(19) United States
(12) Patent Application Publication
(10) Pub. No.: US 2022/0171901 A1
(43) Pub. Date: Jun. 2, 2022

(54) Method for the automated assessment of a simulation model

(71) Applicant: Robert Bosch GmbH, Stuttgart (DE)

(72) Inventors: Johannes Von Keler, Tuebingen (DE); Michael Schmitt, Obersulm-Willsbach (DE); Patrick Hoffmann, Ludwigsburg (DE); Rene Zapf, Markgroeningen (DE); Stephan Rhode, Karlsruhe (DE)

(21) Appl. No.: 17/456,951

(22) Filed: Nov. 30, 2021

(30) Foreign Application Priority Data
Dec. 1, 2020 (DE) 10 2020 215 136.9

(51) Int. Cl. G06F 30/20; G06F 7/57

(52) U.S. Cl. CPC G06F 30/20; G06F 7/57

(57) ABSTRACT

A method for the automated assessment, especially validation, of a simulation model which is used to simulate measured values of a quantity that is defined by one fixed parameter and one varying parameter. Multiple simulation values are determined for the quantity with the aid of the simulation model. Multiple associated reference values are determined for the quantity. For each of multiple values of the varying parameter, in each case a model-form error is determined as deviation between the simulation value with respect to this value of the varying parameter and the reference value with respect to this value of the varying parameter. On the basis of the model-form errors for the multiple values of the varying parameter, a function of the model-form error is determined depending on the varying parameter and used for the assessment, especially validation, of the simulation model.

### FIELD

The present invention relates to a method for the automated assessment, especially validation, of a simulation model, as well as an arithmetic logic unit and a computer program for its implementation.

### BACKGROUND INFORMATION

In order to determine whether a simulation model is able to represent the model system sufficiently well or, for example, to judge the instantaneous quality of a simulation model, such simulation models are assessed or validated. In so doing, reference values, e.g., real measurements, are usually compared to results of the simulation model, and the deviations are examined.

### SUMMARY

The present invention provides a method for the automated assessment of a simulation model, as well as an arithmetic logic unit and a computer program for its implementation, having the features set forth in the independent claims. Advantageous refinements are disclosed herein.

The present invention deals with the automated assessment, especially also validation, of a simulation model. In this context, such a simulation model is used particularly to simulate measured values of a quantity which is defined by (at least) one fixed parameter and (at least) one varying parameter. In so doing, in particular, the time comes into consideration as the varying parameter, so that the quantity may be a time characteristic of a signal, for instance. One example for this is a time characteristic of a vehicle yaw rate, e.g., while the vehicle is cornering. Owing to the simulation of measured values, no real measurements have to be made. One relevant point in this connection, however, is that the simulation model which is used for the simulation—and which also describes the physical properties of the vehicle, for example—is sufficiently good. To that end, a simulation model must be assessed or validated.

In the case of a scalar quantity (only one fixed, but no varying parameter), e.g., the temperature of a certain component in a certain situation, an assessment or validation may be carried out with the aid of what is referred to as an area validation metric. Such an area validation metric may be used to compare two cumulative distribution functions (CDFs) or probability boxes (p-boxes, which is one possibility for representing a family of CDFs). These cumulative distribution functions or probability boxes may be formed from simulations or measurements of a quantity (e.g., temperature or pressure), in due consideration of epistemic and aleatory parameters.

The simulation model has model parameters (e.g., electrical resistance, mechanical coefficient of friction or switching instants). These parameters are either fixed or varying. Varying parameters are subdivided particularly into aleatory and epistemic parameters. Added to these are also loading conditions (or collective loads) or simulation inputs. For example, they may include: the following of a desired vehicle trajectory, or a force and torque characteristic. These inputs may change or vary over time.

Often, however, one single (scalar) value is not of interest, but rather the variation over time (e.g., how the pressure behaves in view of a temperature variation over time), or the position of various points (including uncertainties) relative to each other, for example, in the context of a radar sensor modeling, which exist as vectors. In general, one may thus speak of a quantity which is defined by one fixed parameter and one varying parameter. For example, the varying parameter may be the time, so that the time characteristic mentioned results. It goes without saying that in addition, the quantity may be defined by further fixed and/or varying parameters.

Against this background, in accordance with an example embodiment of the present invention, it is provided that with the aid of the simulation model (which it is necessary to assess or validate) multiple simulation values be determined for the quantity, and that multiple associated reference values be determined for the quantity. In so doing, the reference values are determined specifically with the aid of real measurements. Both simulated data, thus, the simulation values, as well as the reference values usually do not exist as discrete values, but rather as statistical distributions, since various uncertainties must be taken into account. For example, in order to obtain a certain reference value, multiple equivalent measurements may be carried out, so that as a result, a reference value with correspondingly limited measuring uncertainties may be formed, which is able to be represented as a distribution function. Likewise, in the simulation of values, various uncertainties which result from the input values, for example, are taken into account in the resulting simulation value. In particular, however, the simulation should also purposefully reflect uncertainties of the kind which would occur in the case of real measurements, for instance.

For the example of the time characteristic of the quantity, the reference values may thus be determined, e.g., by multiple measurements of a variation of the quantity in question over time. Here, however, not only may repetitive measurements be relevant, for example, but also, e.g., samples from different batches. In this case, the characteristics will differ more or less from each other, which ultimately may be viewed as reference values subject to uncertainties (or a reference characteristic subject to uncertainties). Equivalent to this, for example, would be a family of measured characteristics which accumulate around one specific value. Likewise, the simulation values may be regarded as a family of curves, since epistemic and aleatory uncertainties are considered in the simulation.

For each of multiple values of the varying parameter—thus, for example, at each of multiple points in time—in each case a model-form error is then determined as deviation between the simulation value with respect to this value of the varying parameter (e.g., at this point in time) and the reference value with respect to this value of the varying parameter. In particular, the deviation of the simulation values, modeled with uncertainties, from the reference values filled with measuring uncertainties (or other faults) may be referred to as a model-form error (or model error).

For each individual value of the varying parameter, thus, e.g., at each point in time, a model-form error may thus be determined, as is the case for scalar quantities, for example. In doing so, the model-form error (for each value of the varying parameter) is determined particularly with the aid of the area validation metric already mentioned, in which the deviation between the simulation value and the reference value includes positive and negative deviations. Likewise, however, what is referred to as a modified area validation metric may also be used, in which the deviation between the simulation value and the reference value is determined individually for positive and negative deviations.

The knowledge as to whether the simulation underestimates or overestimates the reference data improves the calculation of the model(-form) error. After the validation, the model-form error is furnished in the form of an uncertainty to the model. In concrete terms, this means that the proposition of the simulation becomes fuzzier. The modified area validation metric tends to supply less fuzziness than the “classic” area validation metric.

When used, the simulation (e.g., simulation of the vehicle cornering) thus delivers less conservative results than is the case when using the “classic” area validation metric. In the case of a purely virtual design, this leads to less oversizing of components or to a smaller safety reserve needed in the designs of controllers.

With respect to a more detailed explanation of the area validation metric and the modified area validation metric, reference is also made at this point to Roy, C. J. and Oberkampf, W. L. (2011), “A Comprehensive Framework for Verification, Validation, and Uncertainty Quantification in Scientific Computing,” Computer Methods in Applied Mechanics and Engineering, Vol. 200, pp. 2131-2144., as well as to Voyles, Ian T. and Christopher J. Roy, “Model Validation Techniques in the Presence of Epistemic and Aleatory Uncertainties,” ASME V&V Conference, May 2014, Las Vegas, Nev.”

On the basis of the model-form error for the multiple values of the varying parameter (or rather, at the relevant points in time), a function of the model-form error is then determined depending on the varying parameter and utilized for assessing the simulation model. In the specific case, this function of the model-form error represents the time as varying parameter, thus, a time characteristic of the model-form error.

This time characteristic of the model-form error—or generally the model-form error represented as function—may subsequently be evaluated (for example, in terms of a maximum, an average value, or a value in the case of a special event, e.g., depending on the application case, etc.), in order to determine a specific model-form error. Alternatively, for example, the area enclosed in the probability box (which is defined by a simulation value) may also be utilized as sensitivity indicator for the later processing of the simulation values, or in general, data obtained by the simulation model. Thus, the model-form error may be evaluated as a function of the model sensitivity, for example.

In general, utilizing the method in accordance with the present invention, a deviation of simulation values from reference—or measured values may thus be determined and used to assess the simulation model. It is conceivable, for instance, that if a deviation is within certain limits, the simulation model may be regarded as validated and/or the ascertained model-form error may be added to the simulation as fuzziness or uncertainty. It should be understood, however, that this may also depend on further factors such as the number of real measurements which go into the reference values.

Consequently, for example, the procedure in accordance with the present invention may facilitate improved and accelerated product development (e.g., safer products), since with a good simulation model (one which was successfully validated or appropriately assessed) that is able to simulate the behavior of the product, real measurements or tests may be supplemented (thus, e.g., real test measurements and simulations may be carried out at the same time) or else reduced or sometimes even avoided. Likewise, for example, simulations or the selection of suitable simulations, e.g., for the validation of models, may be improved. In this connection, the term “virtualized release” may also be used.

Namely, the procedure in accordance with the present invention thus permits the simulation of a system behavior—e.g., the impact energy of a drill hammer, the drying time of the dishes in a dishwasher, the no-load breakaway torque of a steering system, a time characteristic of a vehicle yaw rate or a measured variable of a radar sensor—while taking manufacturing tolerances and variation in operation into consideration. A prediction of the failure of components becomes possible, as well as a robust design of controllers, and an influence of software timings on the system behavior is able to be determined.

An arithmetic logic unit according to the present invention, e.g., a computer or PC, is equipped, particularly in terms of program engineering, to carry out a method according to the present invention.

The implementation of a method according to the present invention in the form of a computer program or computer-program product having program code for carrying out all method steps is also advantageous, since the costs it entails are particularly low, especially if an executing control unit is also being used for other tasks and is therefore present in any case. Suitable data carriers for providing the computer program are, in particular, magnetic, optical and electrical memories like, e.g., hard disks, flash memories, EEPROMs and DVDs, among others. Download of a program via computer networks (Internet, intranet, etc.) is also possible.

Further advantages and refinements of the present invention are derived from the description and the figures.

The present invention is represented schematically in the figures on the basis of an exemplary embodiment, and is described in the following with reference to the figures.

### BRIEF DESCRIPTION OF THE DRAWINGS

FIG. 1A shows exemplarily the construction of an area validation metric for a scalar quantity.

FIG. 1B shows exemplarily a modified area validation metric for a scalar quantity.

FIG. 2A shows exemplarily a measured and simulated time-dependent signal, as may be used in the context of the present invention.

FIG. 2B shows the time characteristic of the area validation metric for the measured and simulated signal from FIG. 2A.

FIG. 2C shows exemplarily a determination of simulation values as vector quantity, as may be used in the context of the invention.

FIG. 2D shows exemplarily a determination of measured values as vector quantity, as may be used in the context of the present invention.

FIG. 3 shows exemplarily a functional sequence of a method according to the present invention in one preferred specific embodiment.

### DETAILED DESCRIPTION OF EXAMPLE EMBODIMENTS

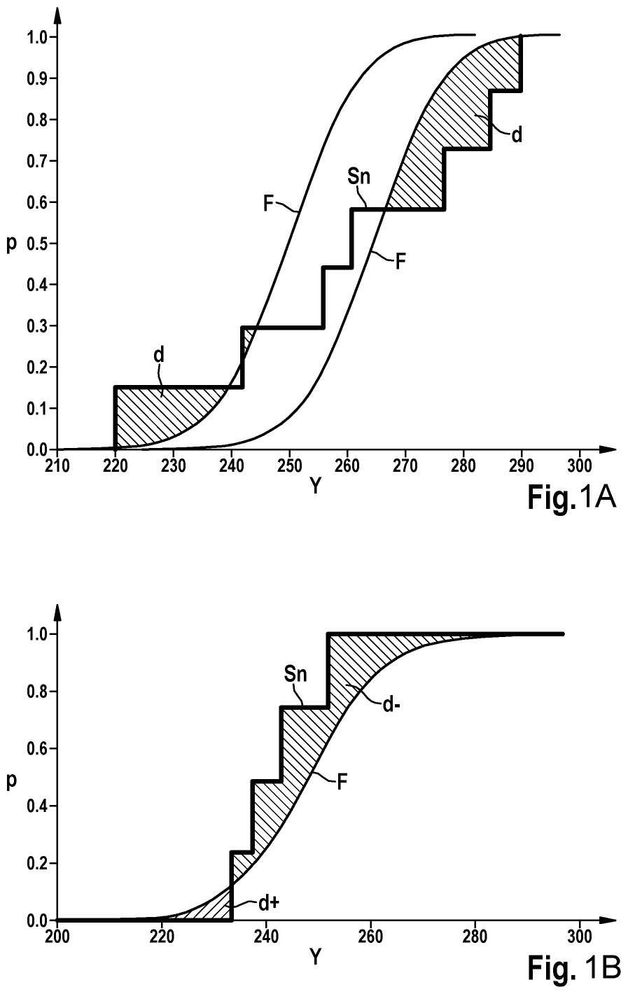

FIG. 1A shows exemplarily and graphically the construction of an area validation metric (AVM) for a scalar quantity or scalar applications in general, which permits a quantitative assessment of deviations between model results and reference data. In this instance, an empirical cumulative distribution function (CDF) Sₙ=Sₙ(Y) is shown. This is obtained from multiple random samples of experimental measurement data, for example, and consequently forms a reference value subject to uncertainties. On the basis of the discrete number of measured values, the cumulative distribution function shown may also be viewed as a cumulative frequency distribution. However, the reference value may also come from other sources, e.g., from a further simulation.

In addition, the quantity or target quantity Y—in this case, it is the scalar quantity which is output with the aid of the simulation model or for which measured values should be simulated—is calculated by a simulation model. If mixed uncertainties are present, thus, both aleatory and interval-characterized epistemic input uncertainties, the propagation of the uncertainties through the simulation model produces a probability box (or p-box) of the simulation target quantity, which is given by a lower and upper boundary and essentially reflects a family of cumulative distribution functions. This is denoted in FIG. 1A by F=F(Y).

While the interval-characterized epistemic input uncertainties determine the horizontal distance of the two boundaries of F, the slope of the two curves is dependent on the aleatory uncertainty. In principle, quantity Y may be any scalar quantity. For example, in FIG. 1A, it is a temperature, but a pressure, for instance, or any other scalar quantity would be conceivable, as well.

The minimal area between these two structures, thus, between the distribution function Sₙ or the reference value and the probability box F of the simulated target quantity, may then be considered as a measure for the difference of the distributions and is referred to as area validation metric d (or Minkowski-L1-Norm) and may also be regarded or referred to as model-form error.

$$d ( F , {S}_{n} ) = {\int }_{- ∞}^{∞} \vert F ( Y ) - {S}_{n} ( Y ) \vert dY .$$

As mentioned, F(Y) indicates the probability box of the simulation for the target quantity Y, and Sₙ(Y) indicates the empirically measured distribution function for the target quantity Y.

The area validation metric d thus obtained has the same units as the target quantity (also referred to as System Response Quantity, SRQ), and thus offers a measure for the discrepancy between simulation and reference. In the assessment of a simulation model, the area validation metric d may therefore also be interpreted as model-form error d, thus, as the error which, in addition to the input uncertainties already propagated, emerge in the modeled result owing to the modeling.

In the graph in FIG. 1A, the relevant area between the two distributions is shown by hatching, a portion of the area lying above the probability box and a portion of the area lying below the probability box. The total area is thus defined essentially by the points of intersection of the reference data with the boundary curves of the probability box.

FIG. 1B shows exemplarily and graphically a modified area validation metric for a scalar quantity or scalar applications, in which besides the area between simulation value F and reference value Sₙ, in addition, the position of the curves relative to each other is also taken into account. In this example, a stepped empirical distribution function is again shown for the reference value. On the other hand, the simulated target quantity F(Y) is likewise shown here as a simple distribution function, thus, corresponding to a probability box with a width of 0. This would correspond to a simulation of the target quantity without epistemic uncertainties. However, the example is likewise transferable to a probability box as in FIG. 1A.

For this modified area validation metric (MAVM), the total area of the area validation metric is once again subdivided, depending upon whether it is a deviation of the reference data from the simulation upward (i.e., toward greater values of Y) or downward (i.e., toward smaller values of Y). Thus, two separate areas between simulation and reference are considered. Consequently, an area d+ is obtained from the region in which the reference result (e.g., from the experiment) is greater than the simulation value (thus, lies above the associated distribution function or p-box of the simulation value), and a second area d− is obtained from the region in which the reference result is less than the simulation value (thus, lies below the associated distribution function or p-box of the simulation value). Thus, the entire model-form error in this case results from the deviation d+ upward and the deviation d− downward. In particular, d− is applied on the left and d+ is applied on the right to the CDF (or probability box), so that they broaden the box. Thus, the model error comes in as a further epistemic uncertainty in the use of the simulation.

Further modifications of these metrics are likewise possible, for example, the additional consideration of a confidence interval for the experimental reference data, so that the reference data are also available in the form of a probability box.

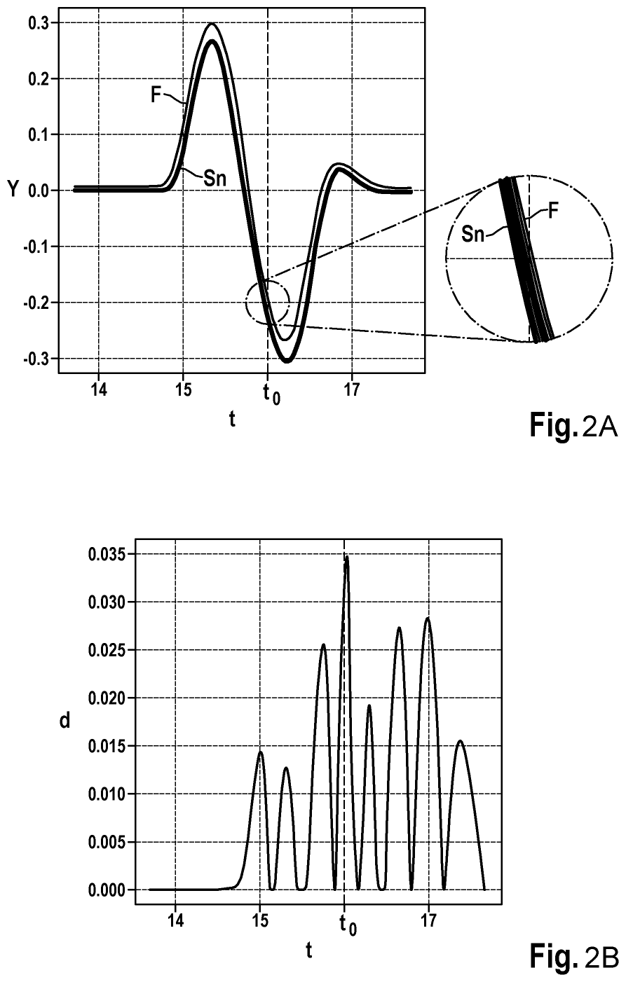

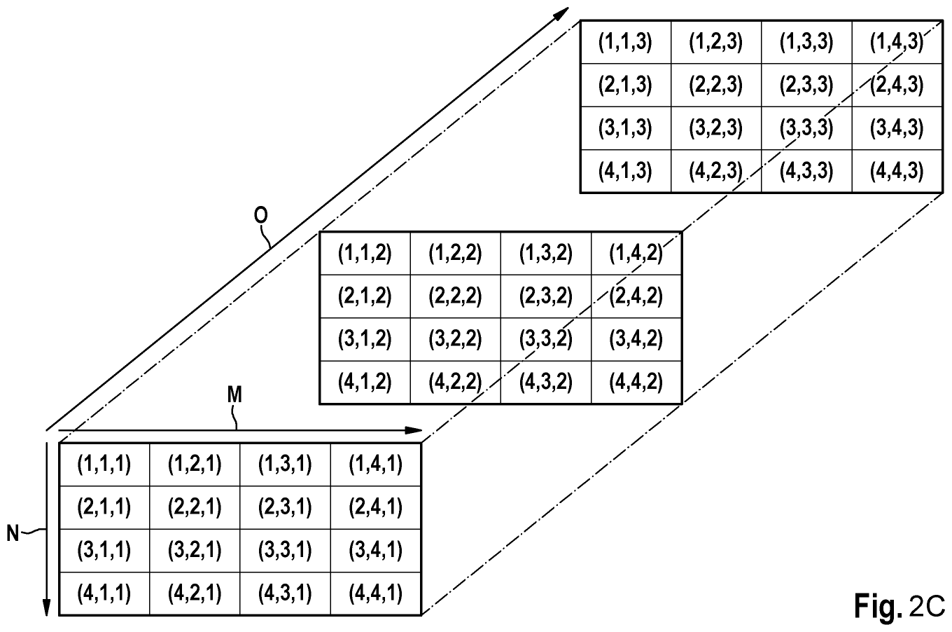

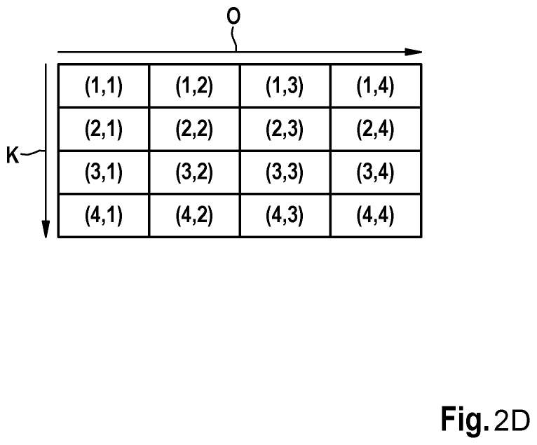

FIG. 2A shows by way of example a measured and simulated time-dependent signal, as may be used within the context of the invention. In this case, the quantity which is to be simulated here has one fixed parameter Y and one varying parameter t. In the example shown, the varying parameter t is the time (plotted in s) and the fixed parameter is a yaw rate (plotted in rad/s), as is of interest, for instance, (as vehicle yaw rate) in driving-dynamics tests in the automotive sector. In this way, a time characteristic of a signal is obtained as quantity. It goes without saying that a different quantity such as the temperature, as in FIGS. 1A, 1B, also comes into consideration as fixed parameter.

The graphic, which shows the yaw rate vs. time, represents what is referred to as a SRQ (System Response Quantity); for example, a steering-wheel angle over time may be used as input (as simulation input). The family of curves is then formed by simulating the input multiple times with varying simulation parameters. These parameters are constant during a simulation (no change during the time).

The simulation values F and the reference values Sₙ are represented in each instance as families of curves, as can be seen in the enlarged cutout. The already mentioned uncertainty may thus be represented.

To calculate an expanded area validation metric within the framework of the invention, each point in time (or at each of certain selected points in time or generally for multiple values of the varying parameters) of this signal characteristic may now be considered, which is intended to be represented by way of example with point in time t₀ (which lies at approximately t=16 s). At each of these points in time, a representation of simulation value and reference value as shown in FIG. 1A or FIG. 1B, for example, may be formed. One idea for the evaluation is thus that for each time step, a p-box (for simulation) and a CDF (for reference data) is constructed and model-form errors d are calculated. Since this is done for each point in time, a d(t), thus, a model-form error d as a function of time t is obtained.

Concerning this, reference is made to the enlarged cutout, in which it can be seen that the simulation values F and the reference values Sₙ are in each case represented as families of curves. The already mentioned uncertainty may thereby be represented. Thus, for example, a density of the curves may be interpreted as a probability distribution or frequency distribution. In the case of real measured values it will be the case, for example, that a high number of measured values will concentrate around an average value, but there will also be individual further deviations upward and downward. This holds true equally for curves and for scalar quantities.

Together with the measured yaw rate Y for this point in time (with the associated uncertainties), the formula

$$d ( F , {S}_{n} ) = {\int }_{- ∞}^{∞} \vert F ( Y ) - {S}_{n} ( Y ) \vert dY$$

may then be applied. In this way, for each point in time of the simulated signal, an area validation metric may be formed, which indicates a model-form error d. From the individual time-dependent values d of the model-form error thus found, a function d(t) of the model-form error may subsequently be formed depending on the time as varying parameter, as shown in FIG. 2A.

In this context, the points at which the area validation metric is evaluated may be determined, for example, as discrete points with predetermined or variable interval, so that, for instance, points are evaluated at an interval of 1 second (or other values such as 0.5 second or 0.1 second). It should be understood that the selection of the suitable points of support may depend, inter alia, on the type of the target quantity. The resulting function of a time-dependent area validation metric may then be found, for example, as interpolation of the discrete values for the area validation metric. Alternatively, it is also conceivable to form no interpolated function, but rather to evaluate the discrete values unchanged.

In similar manner, simulation values may be evaluated which are represented as vectors, for example. This is represented by way of example in FIGS. 2C and 2D. Here, as well, the considered group of data points, for which the validation metric is intended to be used, may be considered depending on (at least) one fixed and (at least) one varying parameter. For example, a target quantity for a data point may be specified as a three-dimensional vector, so that it is made up of at least three different individual values.

To that end, in FIG. 2C, simulation values are shown in three dimensions N, M and O. Each matrix in dimension O is made up of N rows and M columns, which together form a probability box or p-box. For illustration, the entries are denoted here with only the respective position in the three dimensions. In this context, each row forms a cumulative distribution function (CDF). The dimension M thus indicates the aleatory values or uncertainties, whereas the dimension N indicates the epistemic. The dimension O again represents the variation, e.g., over place or time or another dimension.

Corresponding measured values or reference values are shown in FIG. 2D, which in dimension O, like also in the case of FIG. 2C, represents the variation over place or time, for example. On the other hand, dimension K indicates the measuring repetitions or values from one batch. Consequently, the columns here in each case form a cumulative distribution function (CDF) of the measurement.

Like previously in the example of a time characteristic of a signal, separate model-form errors may now be formed for each value of the varying parameter, thus, for the example of the three-dimensional vector, perhaps three individual model-form errors.

As soon as the model-form errors have been found in this or similar manner as a function of the varying parameter, thus, for example, a time characteristic of the model-form error has been determined, this result may be further evaluated in order to attain propositions about the simulation values from it. For example, it may be checked where a local or global maximum or minimum of the function of the model-form error is present in a predetermined interval. On this basis, for example, further decisions may then be made about the simulation or its application, e.g., a necessary improvement of the model or of the model input parameters.

In the same way, certain parameters of interest may be predetermined, e.g., a specific point in time or period of time, and the model-form error may be evaluated in this area. The gradients or average values of the function of the model-form error may also be utilized for various applications.

All in all, the model-form error and further uncertainties of the simulation (input-, parameter-, numerical uncertainty) may be used, for example, to assess potential applications of a model, or to decide on virtual release choices.

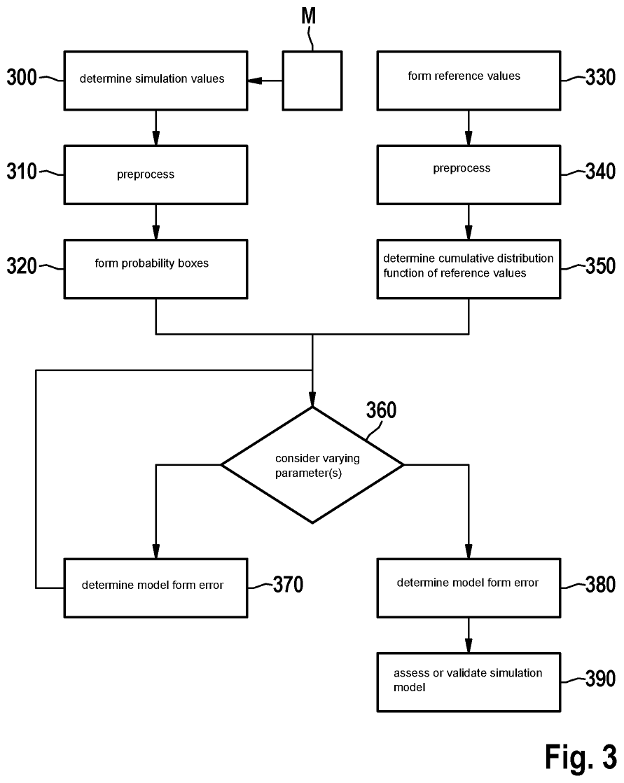

FIG. 3 shows by way of example a functional sequence of a method according to the present invention in one preferred specific embodiment. In step 300, simulation values as shown, e.g., in FIG. 2A or FIG. 2C are determined with the aid of simulation model M to be assessed. This may be carried out, for example, during multiple simulations, whose result in each case is a curve (that represents a time characteristic of a signal, for instance). In the example from FIG. 2C, for instance, N×M simulations would be carried out with O data points each.

In the same way, in step 330, reference values may be formed which may be produced, for example, by measuring the target quantity once or multiple times in a real experiment. The size of the random sample may be preset or may be determined by suitable methods, in doing so, for example, statistical considerations and measuring costs may be taken into account. Insofar as it is a question of a time characteristic as in the example from FIG. 2A, multiple points in time may thus be measured, the points in time and/or their interval being able to be predetermined. Namely, for each individual point in time, multiple measurements may be performed in order to represent the uncertainty of the measurements. For example, a time-dependent experiment may be run through multiple times, and in each case, measurements may be performed at the same points in time, so that multiple measured values are then available for the target quantity for each point in time. In the example from FIG. 2D, for instance, K measurements may be carried out with O data points each.

It should be understood that steps 300 and 330, which for simplicity are shown here in parallel, may take place essentially simultaneously or independently of each other timewise. The reference values, which come from one or more measurements, for example, are usually acquired independently of the simulation. In particular, suitable reference values may also be used to validate multiple different simulation models, and do not necessarily have to be newly formed for each model.

The data obtained from steps 300 and/or 330, in an optional step 310 and/or 340, may also undergo a preprocessing, for instance, by resampling or random-sample repetition, scalings, and the like. It should be understood that any suitable processing steps may be utilized at this point.

From the simulation data thus modeled (step 300) and optionally preprocessed, in step 320, in the general case, for each data point or each value of the varying parameter (in the example from FIG. 2A: at each point in time; in the example from FIG. 2C: for each value of the dimension O) a separate probability box is then formed which reflects the simulation value with its mixed uncertainties. Likewise, in step 350, a corresponding cumulative distribution function of the reference values is determined for each of these values (or points in time).

According to step 360, first of all, a first of multiple varying parameters is considered. For each value (or point in time), according to step 370, a model-form error d is then determined there as described with respect to FIG. 1A, or model-form errors d+, d− may be determined as described with respect to FIG. 1B. This is carried out, if they exist, for all further varying parameters. Subsequently—or for the case of only one varying parameter (as in the example of FIG. 2A) right after the first run-through—according to step 380, the model-form error is determined as a function of the multiple or possibly the one varying parameter. In step 390, the simulation model may then be assessed or validated on the basis of the model-form error.

1-11. (canceled)

12. A method for automated assessment and/or validation of a simulation model, which is used to simulate measured values of a quantity that is defined by a fixed parameter and a varying parameter, the method comprising the following steps:
determining multiple simulation values for the quantity using the simulation model;
determining multiple associated reference values for the quantity;
determining, for each value of multiple values of the varying parameter, a model-form error as a deviation between the simulation value with respect to the value of the varying parameter, and the reference value with respect to the value of the varying parameter; and
determining, based on the model-form errors for the multiple values of the varying parameter, a function of the model-form error depending on the varying parameter, and utilizing the determined function or the assessment and/or validation, of the simulation model.

13. The method as recited in claim 12, wherein the varying parameter is a time, so that the quantity is a time characteristic of the fixed parameter.

14. The method as recited in claim 13, wherein the fixed parameter is predetermined by a signal, so that the quantity is a time characteristic of the signal.

15. The method as recited in claim 12, wherein the reference values are determined by real measurements or by simulations with a higher degree of detail than in the simulation values.

16. The method as recited in claim 12, wherein the simulation model has at least one fixed and at least one varying model parameter, and the simulation values have an uncertainty in the form of a probability distribution which reflects the varying model parameters, and the reference values have an uncertainty in the form of a frequency distribution.

17. The method as recited in claim 12, wherein:
each model-form error is determined using an area validation metric in which the deviation between the simulation value and the reference value includes positive and negative deviations, or
each model-form error is determined using a modified area validation metric, in which the deviation between the simulation value and the reference value is determined individually for positive and negative deviations.

18. The method as recited in claim 12, wherein the quantity includes a time characteristic of a vehicle yaw rate, or a variation of an impact energy of a drill hammer, or a drying time of dishes in a dishwasher, or a variation of a no-load breakaway torque of a steering system, or a measured variable of a radar sensor.

19. The method as recited in claim 12, wherein a software product or a controller is virtualized or released using the assessed and/or validated, simulation model.

20. An arithmetic logic unit configured for automated assessment and/or validation of a simulation model, which is used to simulate measured values of a quantity that is defined by a fixed parameter and a varying parameter, the arithmetic logic unit being configured to:
determine multiple simulation values for the quantity using the simulation model;
determine multiple associated reference values for the quantity;
determine, for each value of multiple values of the varying parameter, a model-form error as a deviation between the simulation value with respect to the value of the varying parameter, and the reference value with respect to the value of the varying parameter; and
determine, based on the model-form errors for the multiple values of the varying parameter, a function of the model-form error depending on the varying parameter, and utilizing the determined function or the assessment and/or validation, of the simulation model.

21. A non-transitory machine-readable storage medium on which is stored a computer program for automated assessment and/or validation of a simulation model, which is used to simulate measured values of a quantity that is defined by a fixed parameter and a varying parameter, the computer program, when executed by an arithmetic logic unit, causing the arithmetic logic unit to perform the following steps:
determining multiple simulation values for the quantity using the simulation model;
determining multiple associated reference values for the quantity;
determining, for each value of multiple values of the varying parameter, a model-form error as a deviation between the simulation value with respect to the value of the varying parameter, and the reference value with respect to the value of the varying parameter; and
determining, based on the model-form errors for the multiple values of the varying parameter, a function of the model-form error depending on the varying parameter, and utilizing the determined function or the assessment and/or validation, of the simulation model.
